(19) United States
(12) Patent Application Publication
(10) Pub. No.: US 2010/0125703 A1
(43) Pub. Date: May 20, 2010

(54) MAGNETIC DISK DEVICE AND CONTROL METHOD THEREOF

(75) Inventor: Yutaka Horiguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/570,922

(22) Filed: Sep. 30, 2009

(30) Foreign Application Priority Data
Nov. 17, 2008 (JP) 2008-293222

(51) Int. Cl. G06F 12/00

(52) U.S. Cl. 711/112; 711/E12.001

(57) ABSTRACT

According to one embodiment, a magnetic disk device is configured to access a disk by a head according to a command from a computer. The magnetic disk device includes a communication module, an information generator, and a controller. The communication module receives a command from the computer. The information generator generates first information indicating the access situation of the disk based on the command received by the communication module. The controller controls the driving speed of at least one of the head and the disk based on the first information generated by the information generator.

### CROSS-REFERENCE TO RELATED APPLICATIONS

This application is based upon and claims the benefit of priority from Japanese Patent Application No. 2008-293222, filed Nov. 17, 2008, the entire contents of which are incorporated herein by reference.

### BACKGROUND

1. Field

One embodiment of the invention relates to a magnetic disk device that accesses a disk by a head, and a control method thereof.

2. Description of the Related Art

Hard disk drive (HDD) devices having various rotation frequencies and seek speeds according to use purposes have been manufactured and sold. When high performance is required, an HDD device that has a high rotation frequency and a high seek speed is used. When low power consumption and low noise are required more than high performance, an HDD device that has a low rotation frequency and a low seek speed is used.

For example, Japanese Patent Application Publication (KOKAI) No. 5-325395 and Japanese Patent Application Publication (KOKAI) No. 2006-338824 discloses, as conventional technologies, a magnetic disk device that controls a seek start interval to remove dusts or a storage device that reduces operation noise, vibration noise, and power consumption.

However, the conventional HDD device is generally mounted on a general-purpose personal computer (PC). Therefore, the use purpose of the HDD device after being shipped is likely to be unknown at the time of the shipment.

When a high-performance HDD device is shipped, the user may complain about the noise, vibration, and heat generation. Meanwhile, if an HDD device with low vibration and noise is shipped, the user may point out the insufficient performance. As such, since the use purpose is unknown at the time of the shipment, needs of the users and product functions may not match.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an HDD device according to a first embodiment of the invention;

FIG. 2 is an exemplary block diagram of the configuration of firmware in the first embodiment;

FIG. 3 is an exemplary flowchart of an access situation measuring process in the first embodiment;

FIG. 4 is an exemplary diagram of a performance setting table in the first embodiment;

FIG. 5 is an exemplary table of performance modes in the first embodiment;

FIG. 6 is an exemplary flowchart of a performance updating process in the first embodiment;

FIG. 7 is an exemplary block diagram of the configuration of firmware according to a second embodiment of the invention;

FIG. 8 is an exemplary flowchart of an access situation measuring process in the second embodiment;

FIG. 9 is an exemplary table of performance modes in the second embodiment;

FIG. 10 is an exemplary flowchart of a performance updating process in the second embodiment;

FIG. 11 is an exemplary block diagram of a host that executes an HDD control program and an HDD device that executes firmware according to a third embodiment of the invention; and

FIG. 12 is an exemplary diagram of a computer system in the third embodiment.

### DETAILED DESCRIPTION

Various embodiments according to the invention will be described hereinafter with reference to the accompanying drawings. In general, according to one embodiment of the invention, a magnetic disk device is configured to access a disk by a head according to a command from a computer. The magnetic disk device comprises a communication module, an information generator, and a controller. The communication module is configured to receive a command from the computer. The information generator is configured to generate first information indicating the access situation of the disk based on the command received by the communication module. The controller is configured to control the driving speed of at least one of the head and the disk based on the first information generated by the information generator.

According to another embodiment of the invention, there is provided a method of controlling a magnetic disk device configured to access a disk by a head according to a command from a computer. The method comprises: generating first information indicating the access situation of the disk based on a command received from the computer by the magnetic disk device; and controlling the driving speed of at least one of the head and the disk based on the first information.

The configuration of an HDD device 1 according to the first embodiment will be described.

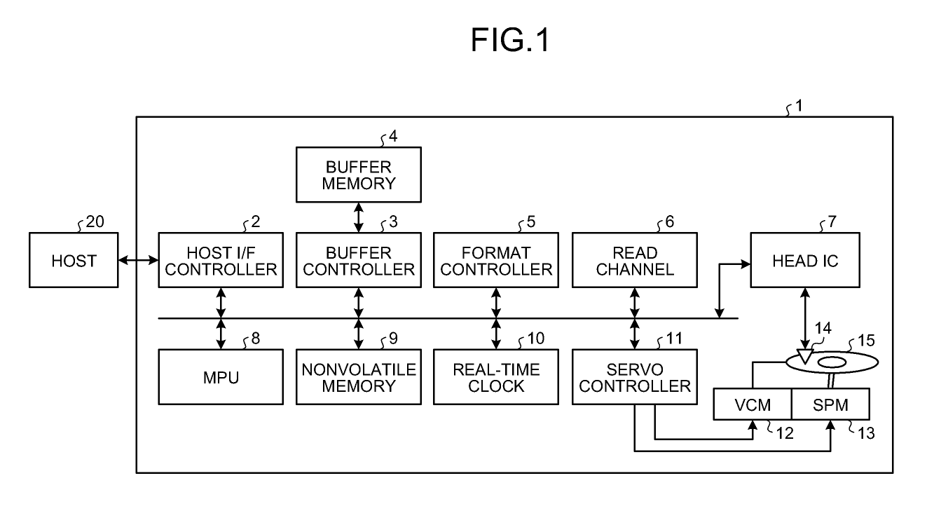

FIG. 1 is a block diagram of an example of the HDD device 1 according to the first embodiment. The HDD device 1 comprises a host interface (I/F) controller 2, a buffer controller 3, a buffer memory 4, a format controller 5, a read channel 6, a head IC 7, a micro processing unit (MPU) 8, a nonvolatile memory 9, a real-time clock 10, a servo controller 11, a voice coil motor (VCM) 12, a spindle motor (SPM) 13, a head 14, and a disk 15. The HDD device 1 is connected to a host 20. The host 20 is a computer (for example, a PC or a server) that comprises a central processing unit (CPU), a storage module, and an I/F controller that controls the interface with the HDD device 1.

The host I/F controller 2 is connected to the host 20 through a host I/F, and communicates with the host 20. Further, the host I/F controller 2 stores a command received from the host 20 in the buffer memory 4. The format controller 5 performs an address management on the disk 15. The read channel 6 modulates write data or demodulates read data. The head IC 7 amplifies a write signal or a read signal to the head 14. The head IC 7 supplies a heater current set by the MPU 8 to a heater of the head 14. The MPU 8 controls the individual components according to firmware. The nonvolatile memory 9 stores a state of the firmware or the HDD device 1. The real-time clock 10 generates a clock as a reference of time measurement and operation timing of the individual components. The servo controller 11 controls the VCM 12 and the SPM 13. The VCM 12 moves the head 14. The SPM 13 rotates the disk 15. The head 14 writes a write signal to the disk 15 and reads a read signal from the disk 15. The disk 15 may be, for example, a magnetic recording medium.

After being shipped in a standard state, the HDD device 1 controls disk rotation frequency (rotational speed per unit time of the disk 15 driven by the SPM 13) and seek speed (moving speed of the head 14 driven by the VCM 12), which affect the performance, according to user's use situation. The control is performed based on the user's use situation.

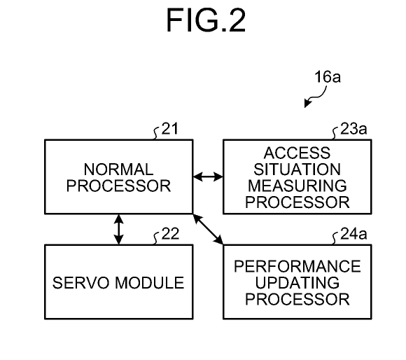

FIG. 2 illustrates an example of the configuration of firmware 16a according to the first embodiment. The firmware 16a implements a normal processor 21, a servo module 22, an access situation measuring processor 23a, and a performance updating processor 24a. The MPU 8 performs the processes of the individual modules of the firmware 16a.

The normal processor 21 performs normal operation (writing, reading, etc.). The access situation measuring processor 23a performs statistical process of access to the disk 15, and performs an access situation measuring process to measure a result of the statistical process (statistical result) as an access situation. The performance updating processor 24a performs a performance updating process to update performance (driving speed). The servo module 22 allows the servo controller 11 to control the VCM 12 and the SPM 13, in accordance with a setting value of performance mode updated by the performance updating processor 24a.

Next, the access situation measuring process performed by the access situation measuring processor 23a will be described.

The access situation measuring process is repetitively performed during a normal process of the HDD device 1.

The HDD device 1 according to the first embodiment uses a statistical result for access frequency as an access situation.

During the access situation measuring process, the MPU 8 uses a command time interval timer to measure a command time interval as a time from an immediately previous specified command (first command) to a newest specified command, and sets the command time interval as access frequency. The command time interval timer counts the clock generated by the real-time clock 10. In this case, the specified command is a command related to access to (read from or write to) the disk 15. An access frequency state (state) according to a command time interval of the specified command is defined as follows:

Mode 0 (First State)

command time interval is shorter than 0.3 sec.

(frequency of a specified command is more than a first frequency threshold value (1/(0.3 sec.))

Mode 1

command time interval is not shorter than 0.3 sec. and shorter than 3 sec.

Mode 2 (Second State)

command time interval is not shorter than 3 sec. and shorter than 30 sec.

(frequency of a specified command is less than a second frequency threshold value (1/(3 sec.))

Mode 3 (Idle State)

command time interval is not shorter than 30 sec.

During the access situation measuring process, the MPU 8 recognizes the current access frequency state, and stores state maintained times (Mode 0 time, Mode 1 time, Mode 2 time, and Mode 3 time) (first information), i.e., a time period for which each access frequency state is maintained, in the buffer memory 4. The state maintained time for each access frequency state indicates a frequency distribution of access (specified command).

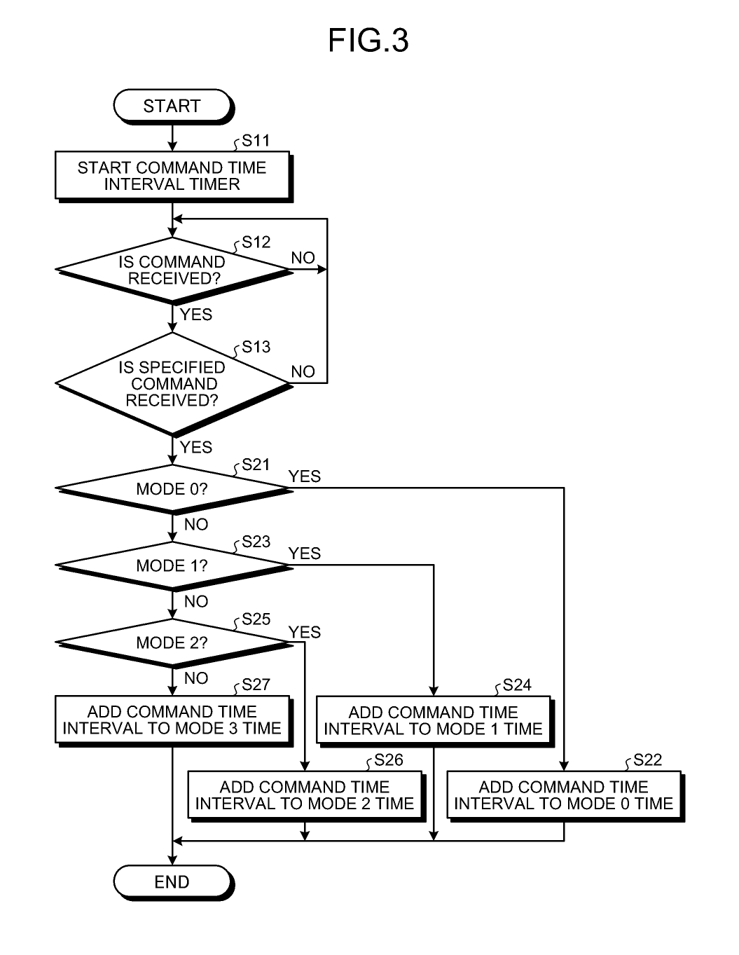

The access situation measuring process is repetitively performed during the normal process of the HDD device 1. FIG. 3 is a flowchart of an example of the access situation measuring process according to the first embodiment. First, the MPU 8 starts the command time interval timer to measure the command time interval (S11). Next, the MPU 8 determines whether a command is received from the host 20 (S12).

When it is determined that the command is not received (S12, No), the process proceeds to S12. When determining that the command is received (Yes at S12), the MPU 8 determines whether the received command is the specified command (S13).

When it is determined that the received command is not the specified command (No at S13), the process proceeds to S12. When determining that the received command is the specified command (Yes at S13), the MPU 8 determines whether an access frequency state is in Mode 0 based on the command time interval measured by the command time interval timer (S21).

When determining that the access frequency state is in Mode 0 (Yes at S21), the MPU 8 adds the command time interval to the Mode 0 time (S22), and the process ends.

When determining that the access frequency state is not in Mode 0 (No at S21), the MPU 8 determines whether the access frequency state is in Mode 1 (S23).

When determining that the access frequency state is in Mode 1 (Yes at S23), the MPU 8 adds the command time interval to the Mode 1 time (S24), and the process ends.

When determining that the access frequency state is not in Mode 1 (No at S23), the MPU 8 determines whether the access frequency state is in Mode 2 (S25).

When determining that the access frequency state is in Mode 2 (Yes at S25), the MPU 8 adds the command time interval to the Mode 2 time (S26), and the process ends.

When determining that the access frequency state is not in Mode 2 (No at S25), the MPU 8 adds the command time interval to the Mode 3 time (S27), and the process ends.

When the HDD device 1 completes the operation, the MPU 8 writes each state maintained time stored in the buffer memory 4 to a system area of the disk 15. When the HDD device 1 is activated, the MPU 8 writes each state maintained time stored in the system area of the disk 15 to the buffer memory 4.

The performance updating process performed by the performance updating processor 24a will be described.

A performance setting table to set performance mode of the HDD device 1 and current performance mode are stored in the system area of the disk 15 in advance.

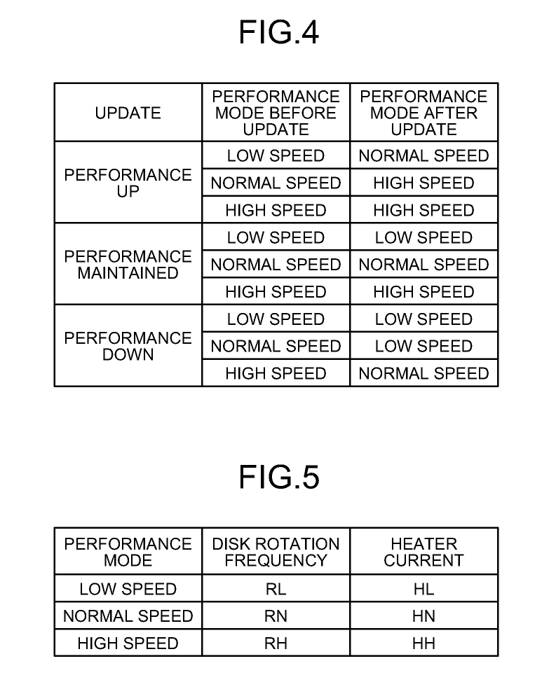

FIG. 4 illustrates an example of the performance setting table according to the first embodiment. The performance setting table indicates the types of update of performance mode, (performance up, performance maintained, and performance down), performance mode before the update, and performance mode after the update. As the performance modes, Low Speed, Normal Speed, and High Speed are defined in the order of low performance. A performance mode when the HDD device 1 is shipped from a factory is defined as Normal Speed.

The performance setting table may not necessarily be defined in advance. In this case, the performance mode is represented by a numerical value, and when the numerical value is high, the performance is high. In the case of performance up, the performance mode is increased by 1. In the case of performance maintained, the performance mode is not changed. In the case of performance down, the performance mode is decreased by 1.

FIG. 5 illustrates an example of performance modes according to the first embodiment. The performance modes are associated with setting values of disk rotation frequency (RL, RN, and RH) and setting values of heater current of the head 14 (HL, HN, and HH), respectively. When the performance mode is high, the setting value of the disk rotation frequency is high and that of the heater current is high. If the heater current of the head 14 is set according to the disk rotation frequency, the protrusion amount of the head 14 is controlled such that the floating amount of the head 14 is appropriate. For example, if the disk rotation frequency is increased, the floating amount of the head 14 is increased. Therefore, the protrusion amount of the head 14 is increased by increasing the heater current.

The performance updating process is performed when the HDD device 1 is activated.

The performance updating process may be performed at predetermined timing. The predetermined timing may be, for example, timing that is set at a predetermined update time interval. During the performance updating process, the performance mode is preferably changed in a state where the head 14 is retracted outside the disk 15.

During the performance updating process, the MPU 8 measures a Power ON time (time elapsed since Power ON, i.e., running time).

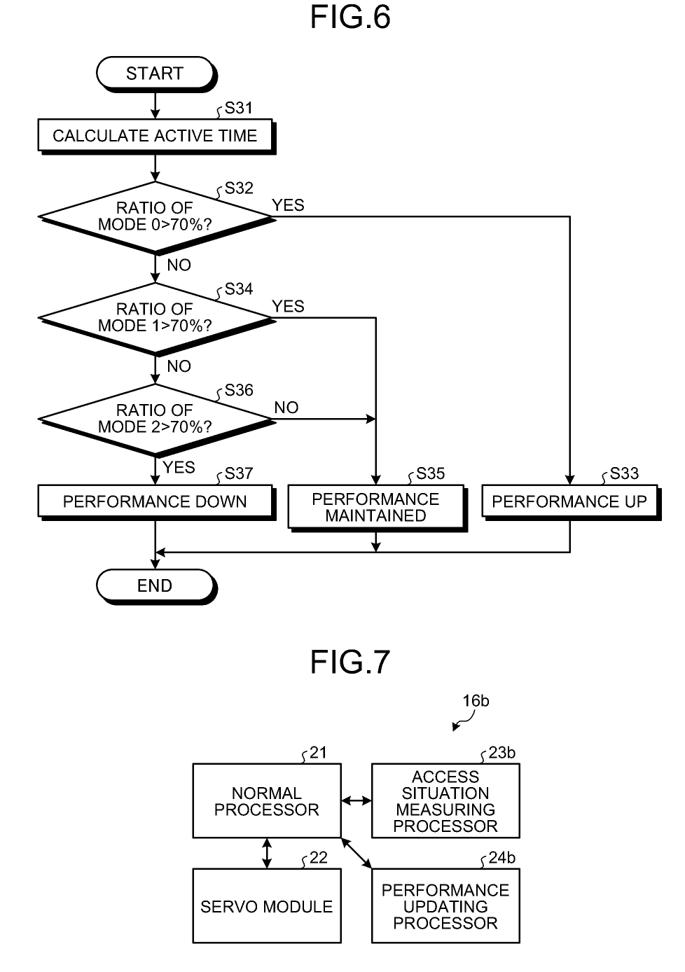

FIG. 6 is a flowchart of an example of the performance updating process according to the first embodiment. First, the MPU 8 calculates an Active time (S31). In this case, the Active time=the Power On time−the Mode 3 time (or the Mode 0 time+the Mode 1 time+the Mode 2 time).

Next, the MPU 8 calculates a Mode 0 ratio=a Mode 0 time/an Active time, and determines whether the Mode 0 ratio exceeds 70% (first time ratio threshold value) (S32).

When determining that the Mode 0 ratio exceeds 70% (Yes at S32), the MPU 8 determines that the performance is insufficient because the access frequency is high, and therefore increases the performance mode by one level (performance up) (S33). Then, the process ends.

When determining that the Mode 0 ratio does not exceed 70% (No at S32), the MPU 8 calculates a Mode 1 ratio=a Mode 1 time/an Active time, and determines whether the Mode 1 ratio exceeds 70% (first time ratio threshold value) (S34).

When determining that the Mode 1 ratio exceeds 70% (Yes at S34), the MPU 8 determines that the performance is appropriate because the access frequency is appropriate, and therefore does not change the performance mode (performance maintained) (S35). Then, the process ends.

When determining that the Mode 1 ratio does not exceed 70% (No at S34), the MPU 8 calculates a Mode 2 ratio=a Mode 2 time/an Active time, and determines whether the Mode 2 ratio exceeds 70% (second time ratio threshold value) (S36).

When determining that the Mode 2 ratio exceeds 70% (Yes at S36), the MPU 8 determines that the performance is excessive because the access frequency is low, and therefore decreases the performance mode by one level (performance down) (S37). Then, the process ends.

When it is determined that the Mode 2 ratio does not exceed 70% (No at S36), the process proceeds to S35.

The MPU 8 writes a performance mode updated by the performance updating process to the system area of the disk 15.

The access situation measuring processor 23a may calculate the Active time, the Mode 0 ratio, the Mode 1 ratio, and the Mode 2 ratio, and write them to the system area of the disk 15.

The MPU 8 performs the normal process after the performance updating process.

The variation in the disk rotation frequency affects the floating amount of the head 14. However, the distance between the head 14 and the disk 15 can be optimally maintained by controlling the disk rotation frequency and the heater of the head 14.

As described above, according to the first embodiment, the performance of the HDD device 1 can be set to be appropriate by controlling the disk rotation frequency based on the access frequency.

A second embodiment of the invention will be described. An HDD device of the second embodiment is of basically the same configuration as that of the HDD device of the first embodiment except for firmware.

FIG. 7 illustrates an example of the configuration of firmware 16b according to the second embodiment. In FIG. 7, constituent elements corresponding to those of FIG. 2 are designated by the same reference numerals, and their description will not be repeated. As compared with the firmware 16a of the first embodiment, the firmware 16b of the second embodiment implements an access situation measuring processor 23b and a performance updating processor 24b, instead of the access situation measuring processor 23a and the performance updating processor 24a.

Next, the access situation measuring process performed by the access situation measuring processor 23b will be described.

The HDD device 1 of the second embodiment uses, as access situation, a statistical result as to frequency with respect to each access pattern. The access pattern indicates a sequential access or a random access.

During the access situation measuring process, the MPU 8 recognizes the types of specified commands received from the host 20. The types of the specified commands are defined as follows:

Type A (First Type)

sequential access command

Type B

random access command where a time interval with an immediately previous specified command is not longer than 0.3 sec.

Type C (Second Type)

random access command where a time interval with an immediately previous specified command is longer than 0.3 sec. (frequency of a specified command is less than a first threshold value (1/(0.3 sec.))

During the access situation measuring process, the MPU 8 stores count values (a Type A count value, a Type B count value, and a Type C count value) (first information), i.e., the number of specified commands of each recognized type, in the buffer memory 4. The count value for each type indicates a frequency distribution for each access pattern.

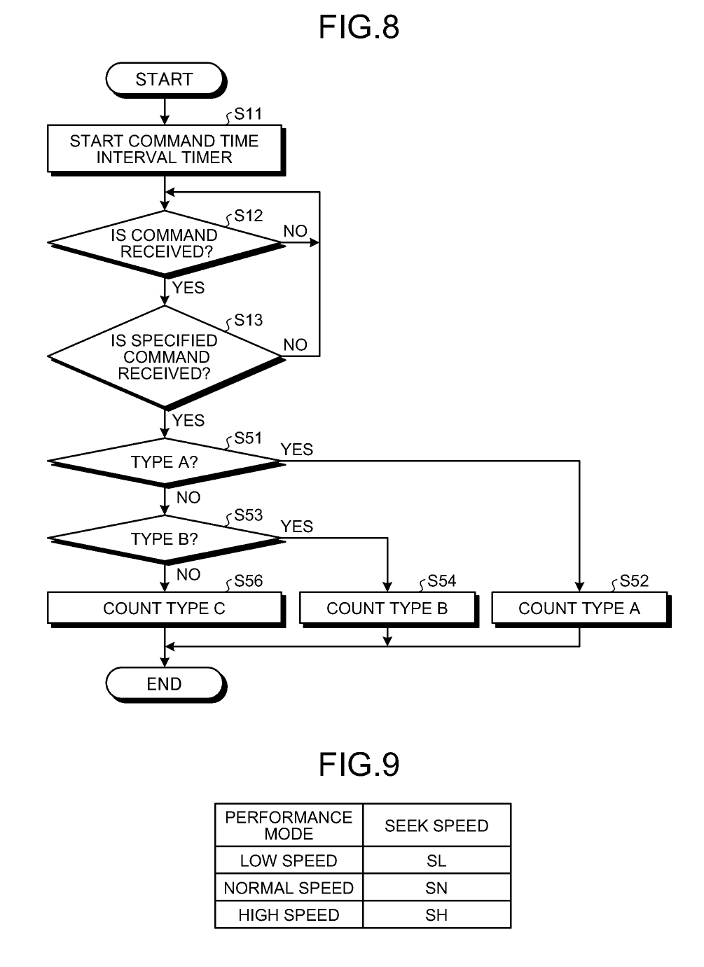

FIG. 8 is a flowchart of an example of the access situation measuring process according to the second embodiment. First, the MPU 8 starts the command time interval timer to measure the command time interval (S11). Next, the MPU 8 determines whether a command is received from the host 20 (S12).

When it is determined that the command is not received (No at S12), the process proceeds to S12. When determining that the command is received (Yes at S12), the MPU 8 determines whether the received command is the specified command (S13).

When it is determined that the received command is not the specified command (No at S13), the process proceeds to S12. When determining that the received command is the specified command (Yes at S13), the MPU 8 determines whether the received command is the command of the Type A (S51).

When determining that the received command is the command of the Type A (Yes at S51), the MPU 8 increases the Type A count value by 1 (S52), and the process ends.

When determining that the received command is not the command of the Type A (No at S51), the MPU 8 determines whether the received command is the command of the Type B (S53).

When determining that the received command is the command of the Type B (Yes at S53), the MPU 8 increases the Type B count value by 1 (S54), and the process ends.

When determining that the received command is not the command of the Type B (No at S51), the MPU 8 determines that the received command is the command of the Type C, and increases the Type C count value by 1 (S56), and the process ends.

When the HDD device 1 completes the operation, the MPU 8 writes each access pattern stored in the buffer memory 4 to a system area of the disk 15. When the HDD device 1 is activated, the MPU 8 writes each access pattern stored in the system area of the disk 15 to the buffer memory 4.

The performance updating process performed by the performance updating processor 24b will be described.

The format of the performance setting table according to the second embodiment is basically the same as that of the first embodiment except for a setting value in each performance mode.

FIG. 9 illustrates an example of performance modes according to the second embodiment. The performance modes are associated with setting values of seek speeds (SL, SN, and SH), respectively. When the performance mode is high, the setting value of the seek speed is high.

The performance updating process is performed when the HDD device 1 is activated.

The performance updating process may be performed at predetermined timing.

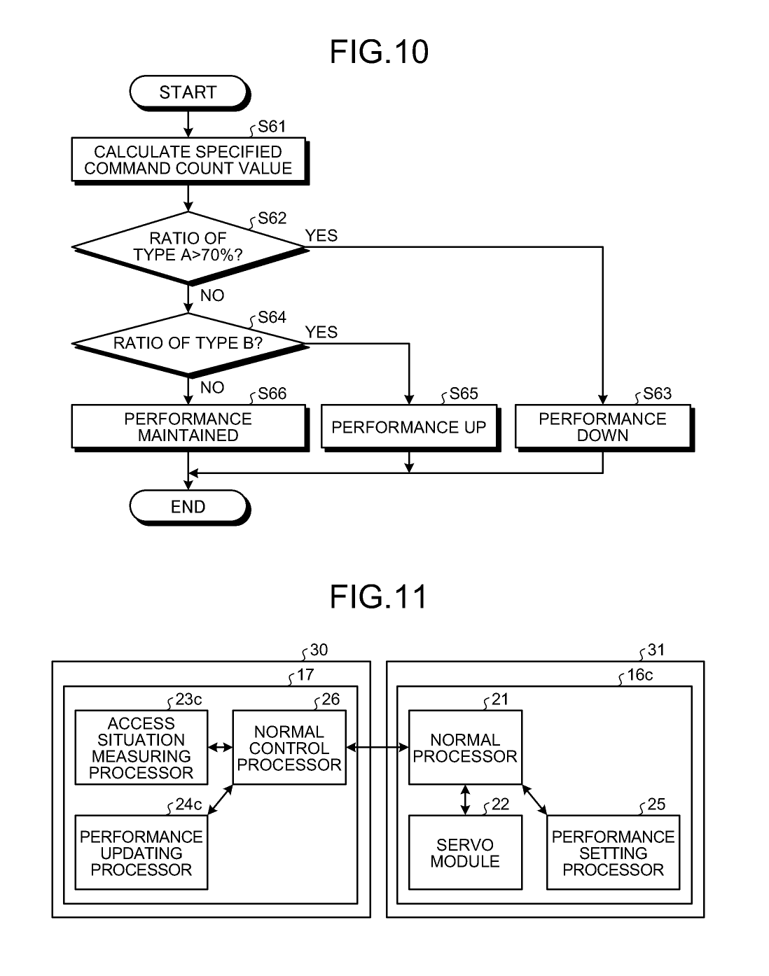

FIG. 10 is a flowchart of an example of the performance updating process according to the second embodiment. First, the MPU 8 calculates a specified command count value (S61). In this case, the specified command count value=a Type A count value+a Type B count value+a Type C count value.

Next, the MPU 8 calculates a Type A ratio=a Type A count value/a specified command count value, and determines whether the Type A ratio exceeds 70% (first count ratio threshold value) (S62).

When determining that the Type A ratio exceeds 70% (Yes at S62), the MPU 8 determines that the frequency of the sequential access is high, and therefore decreases the performance mode by one level (performance down) (S63). Then, the process ends.

When determining that the Type A ratio does not exceed 70% (No at S62), the MPU 8 calculates a Type B ratio=a Type B cont value/a specified command count value, and determines whether the Type B ratio exceeds 70% (second count ratio threshold value) (S64).

When determining that the Type B ratio exceeds 70% (Yes at S64), the MPU 8 determines that the frequency of the random access is high, and therefore increases the performance mode by one level (performance up) (S65). Then, the process ends.

When determining that the Type B ratio does not exceed 70% (No at S64), the MPU 8 determines that the ratio of the random access is high but the frequency thereof is not high, and therefore does not change the performance mode (performance maintained) (S66). Then, the process ends.

The access situation measuring processor 23b may calculate the specified command count value, the Type A ratio, the Type B ratio, and the Type C ratio, and may write them to the system area of the disk 15.

According to the second embodiment, the performance of the HDD device 1 can be set to be appropriate by controlling the seek speed based on the access pattern.

An access pattern for the HDD device 1 is different depending on the use purpose of the user. For example, when the host 20 is a server, the frequency of the random access increases. When the frequency of the random access is high, an increase in the seek speed is effective to improve performance.

The access situation measuring process and the performance updating process of the first embodiment and those of the second embodiment may be applied to the HDD device 1 in combination.

A third embodiment of the invention will be described. A computer program (hereinafter, “HDD control program”) may be executed by the CPU of the host to control the HDD device to thereby implement the access situation measuring process and the performance updating process. The HDD control program may be stored in the HDD device or in another storage medium.

FIG. 11 is a block diagram of an example of the configuration of a host 30 that executes an HDD control program 17 and an HDD device 31 that executes firmware 16c according to the third embodiment. The hardware configuration of the HDD device 31 of the third embodiment is basically the same as that of the HDD device 1 of the first embodiment except that the HDD device 31 is provided with the firmware 16c that is executed by the MPU 8. The hardware configuration of the host 30 of the third embodiment is basically the same as that of the host 20 of the first embodiment except that the host 30 is provided with the HDD control program 17 that is executed by the CPU of the host 30.

The HDD control program 17 (control program of the magnetic disk device) implements a normal control processor 26, an access situation measuring processor 23c, and a performance updating processor 24c.

The normal control processor 26 performs command control (writing, reading, etc.) of the normal HDD device. The access situation measuring processor 23c monitors a command issued from the normal control processor 26 to the HDD device 31, and performs the access situation measuring process. The performance updating processor 24c determines a performance mode by the performance updating process, and issues a command for setting the performance mode to the HDD device 31.

The firmware 16c implements the normal processor 21, the servo module 22, and a performance setting processor 25.

When the performance setting processor 25 of the HDD device 31 receives the command for setting the performance mode, the performance setting processor 25 sets performance (disk rotation frequency or seek speed) defined as the performance mode.

The HDD control program 17 maybe included in an operating system (OS).

According to the above embodiments, even if the HDD device (1, 31) is used for various purposes, the performance of the HDD device can be set to be appropriate for the user environment.

While, in the above embodiments, the number of the performance modes is three, but may be two, or four or more. Besides, instead of the performance mode, an expression for calculating a driving speed from an access situation or an algorithm may be applied to the performance updating process.

In the above embodiments, information of the access situation or the performance mode is written to a nonvolatile storage medium, such as the system area of the disk 15, and read when the HDD device 1 is activated. The nonvolatile storage medium may be the nonvolatile memory 9.

The MPU 8 writes update history of the performance mode by the performance updating process in the system area of the disk 15. During the performance updating process, the MPU 8 may read history and determine a new performance mode on the basis of the history. The performance updating process prevents excessive performance change.

The MPU 8 may set a statistical result where a read command and a write command are classified as an access situation, and execute an access situation measuring process and a performance updating process. For example, when frequency of the read command is high, the MPU performs control for increasing a seek speed affecting the read performance.

The MPU 8 may set a statistical result of the read or write data amount as the access situation.

The communication module corresponds to the host I/F controller 2. The information generator corresponds to the access situation measuring processors 23a and 23b. The controller corresponds to the performance updating processors 24a and 24b and the servo module 22.

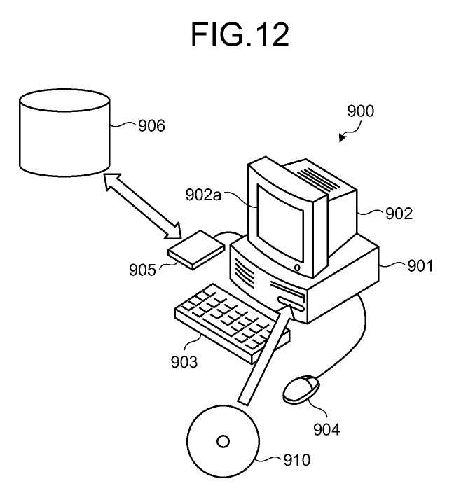

The above embodiments may be implemented by a computer system as described below. FIG. 12 illustrates an example of such a computer system. As illustrated in FIG. 12, a computer system 900 comprises a body 901 including a CPU or a disk drive, a display 902 that displays an image according to an instruction from the body 901, a keyboard 903 used to input various information to the computer system 900, a mouse 904 that designates an arbitrary position on a display screen 902a of the display 902, and a communication device 905 that accesses an external database to download a program or the like stored in another computer system. The communication device 905 may be, for example, a network communication card or a modem.

In the computer system that constitutes the host, a program that implements the above processes may be provided as the HDD control program. The program may be stored in a recording medium readable by the computer system and executed by the computer system constituting the host. The program may also be stored in a portable recording medium such as a disk 910, or downloaded by the communication device 905 from a recording medium 906 of another computer system. The HDD control program that provides the computer system 900 with at least HDD control function is installed on the computer system 900 and compiled. The HDD control program causes the computer system 900 to operate as an HDD control system with the HDD control function. The HDD control program may be stored in a computer readable recording medium such as the disk 910. Examples of the recording medium readable by the computer system 900 include an internal storage device such as a ROM or a RAM mounted in the computer system 900, a portable storage medium such as the disk 910, a flexible disk, a DVD disk, a magneto optical disk, and an IC card, a database that stores computer programs, another computer system and a database thereof, and various recording media connectable to the computer system 900 through a communication module such as the communication device 905 and accessible.

As set forth hereinabove, according to an embodiment of the invention, when the user often requires peak performance in the user environment (performance is significantly insufficient), an HDD device increases disk rotation frequency or seek speed and enters in a state where performance is improved. Further, when the peak performance is not required in the user environment, the HDD device decreases disk rotation frequency or seek speed and enters in a state where noise, vibration, and power consumption are suppressed. Thus, performance of a magnetic disk device can be adjusted to be suitable for an access situation.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device configured to access a disk by a head according to a command from a computer, the magnetic disk device comprising:
a communication module configured to receive a command from the computer;
an information generator configured to generate first information indicating access situation of the disk based on the command received by the communication module; and
a controller configured to control a driving speed of at least one of the head and the disk based on the first information generated by the information generator.

2. The magnetic disk device of claim 1, wherein the information generator is configured to detect a first command related to access to the disk from among commands received by the communication module, performs a statistical process related to the first command to obtain a statistical result, and sets the statistical result as the first information.

3. The magnetic disk device of claim 2, wherein the first information is frequency distribution with respect to each access pattern of the first command.

4. The magnetic disk device of claim 3, wherein the driving speed is a moving speed of the head.

5. The magnetic disk device of claim 3, wherein the information generator is configured to recognize a type of the first command received by the communication module based on a plurality of types previously defined by frequency with respect to each access pattern of the first command, count the first command recognized as of each of the types, and generates the first information based on a count value obtained for each of the types.

6. The magnetic disk device of claim 5, wherein
the types include a first type which makes it a condition that the first command is a sequential access command, and
the controller is configured to decrease the driving speed when a ratio of the count value of the first type with respect to count values of all the types is more than a predetermined first count threshold value.

7. The magnetic disk device of claim 5, wherein
the types include a second type which makes it a condition that the first command is a random access command and frequency of the first command is less than a predetermined first threshold value, and
the controller is configured to increase the driving speed when a ratio of the count value of the second type with respect to count values of all the types is more than a predetermined second count ratio threshold value.

8. The magnetic disk device of claim 2, wherein the first information is frequency distribution of the first command.

9. The magnetic disk device of claim 8, wherein the driving speed is a rotational speed of the disk.

10. The magnetic disk device of claim 9, wherein the controller is configured to control a heater of the head according to the rotational speed of the disk.

11. The magnetic disk device of claim 8, wherein frequency of the first command is represented by a time difference between a newest first command received by the communication module and the first command received immediately before the newest first command.

12. The magnetic disk device of claim 8, wherein the information generator is configured to recognize a current state based on a plurality of states previously defined by frequency of the first command and the frequency of the first command received by the communication module, measure a maintained time for which each of the states is maintained, and generate the first information based on the maintained time obtained for each of the states.

13. The magnetic disk device of claim 12, wherein
the states include an idle state,
the information generator is configured to subtract the maintained time of the idle state from a running time of the magnetic disk to obtain an active time, and
the controller is configured to determine the driving speed based on a ratio of the maintained time to the active time.

14. The magnetic disk device of claim 13, wherein
the states include a first state where the frequency of the first command received by the communication module is more than a predetermined first frequency threshold value, and
the controller is configured to increase the driving speed when a ratio of the maintained time of the first state with respect to the active state is more than a predetermined first time ratio threshold value.

15. The magnetic disk device of claim 13, wherein
the states include a second state where the frequency of the first command received by the communication module is less than a predetermined second frequency threshold value, and
the controller is configured to increase the driving speed when a ratio of the maintained time of the second state with respect to the active state is more than a predetermined second time ratio threshold value.

16. The magnetic disk device of claim 1, wherein the controller is configured to control the driving speed at predetermined timing.

17. The magnetic disk device of claim 16, wherein the predetermined timing is when the magnetic disk device is activated.

18. The magnetic disk device of claim 17, wherein
the information generator is configured to store the first information in a nonvolatile storage medium, and
the controller is configured to read the first information from the nonvolatile storage medium, and control the driving speed based on the first information.

19. The magnetic disk device of claim 16, wherein the predetermined timing is set at predetermined update time intervals.

20. A method of controlling a magnetic disk device configured to access a disk by a head according to a command from a computer, the method comprising:
generating first information indicating access situation of the disk based on a command received from the computer by the magnetic disk device; and
controlling a driving speed of at least one of the head and the disk based on the first information.
